(19) United States
(12) Patent Application Publication
(10) Pub. No.: US 2004/0264929 A1
(43) Pub. Date: Dec. 30, 2004

(54) Information storage medium storing information for generating DTV stream, and method and apparatus for converting DTV stream

(75) Inventors: Jae-sun Lee, Osan-si (KR); Jung-wan Ko, Suwon-si (KR); Sung-wook Park, Seoul (KR); Hyun-kwon Chung, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/626,867

(22) Filed: Jul. 25, 2003

(30) Foreign Application Priority Data
Jul. 26, 2002 (KR) 2002-44302

(51) Int. Cl. H04N 5/781

(52) U.S. Cl. 386/95; 386/125

(57) ABSTRACT

An information storage medium storing information to generate digital television (DTV) streams, and a method and an apparatus to convert DTV streams are provided. The information storage medium includes multi-streams, interactive contents including information that enables interface with a user, and reproduction control information including conversion information to convert the multi-streams and/or the interactive contents into digital television (DTV) streams.

### CROSS-REFERENCE TO RELATED APPLICATIONS

This application claims the priority of Korean Patent Application No. 2002-44302, filed on Jul. 26, 2002, in the Korean Intellectual Property Office, which is incorporated herein in its entirety by reference.

### BACKGROUND OF THE INVENTION

1. Field of the Invention

The present invention relates to an information storage medium storing information to generate digital television (DTV) streams, and a method and an apparatus to convert DTV streams, and more particularly, to an information storage medium storing multi-streams, interactive contents, and reproduction control information, and a method and an apparatus to convert information recorded on an information storage medium into bit-streams reproducible in a DTV.

2. Description of the Related Art

Because a conventional read-only memory (ROM) type information storage medium, such as a digital versatile disc-video (DVD-video) disc, and a reproducing apparatus therefore, do not include data, information structure, and devices that can be reproduced in a DTV, the information recorded on the storage medium cannot be reproduced in the DTV. A block diagram of a DVD-video reproducing apparatus is shown in FIG. 1.

Referring to FIG. 1, the DVD-video reproducing apparatus is formed of a read-out unit 12 that reads out data from an optical disc 11, for example, a DVD-video disc, and a controller 14 that receives user commands via a user interface and provides a command control signal to a presentation/navigation engine 13. Here, the presentation/navigation engine 13 includes a navigation engine, which parses and executes reproduction control information that manages the user interface, and reproduces sequences of the data read out from the optical disc 11 using the read-out unit 12, and a presentation engine, which decodes main bit streams and interactive contents read out from the optical disc 11 using a selected reproducing sequence. In other words, a navigation part of the presentation/navigation engine 13 manages the user interface and the reproducing sequence, and a presentation part of the presentation/navigation engine 13 decodes and reproduces multi-stream and interactive contents, which are represented as titles or programs. The navigation part of the presentation/navigation engine 13 selects the titles or the programs.

Here, the conventional ROM-type information storage medium, such as the DVD-video disc, follows a standard that is independent from the data of DTV. Thus, when the information recorded on the ROM-type information storage medium is provided to the DTV by using a digital interface, the information is not converted into bit streams having an information structure that can be parsed and presented by the DTV. Accordingly, the conventional ROM-type information storage medium does not have a proper data type or information structure to be reproduced on the DTV. Thus, it is impossible to convert the data recorded on the ROM-type information storage medium into signals that can be reproduced on the DTV, in a conventional reproducing apparatus that reproduces the conventional ROM-type information storage medium.

### SUMMARY OF THE INVENTION

The present invention provides an information storage medium storing multi-streams, interactive contents, and reproduction control information including conversion information to convert data into multi-streams and the interactive contents into digital television (DTV) streams.

The present invention also provides a method and an apparatus to convert data recorded on an optical disc storing multi-streams, interactive contents, and reproduction control information into streams, including DTV streams, that can be reproduced on a DTV.

According to an aspect of the present invention, there is provided an information storage medium including multi-streams, interactive contents including information that enables an interface with a user, and reproduction control information including conversion information to convert the multi-streams and/or the interactive contents into digital television (DTV) streams.

According to another aspect of the present invention, there is provided a method to reproduce data recorded on an information storage medium on a DTV, the method includes reading out multi-streams, interactive contents, and reproduction control information from the information storage medium having conversion information to convert the multi-streams and/or the interactive contents into DTV streams; converting the read-out multi-streams into transport streams appropriate to the DTV; converting the read-out interactive contents into DTV interactive contents; and multiplexing the transport streams and the DTV interactive contents based on the read-out reproduction control information to generate DTV streams.

According to yet another aspect of the present invention, there is provided an optical recording/reproducing apparatus to reproduce data recorded on an information recording medium on a DTV, the apparatus including a read-out unit reading out multi-streams, interactive contents, and reproduction control information from the information storage medium having conversion information to convert the multi-streams and/or the interactive contents into DTV streams; a first transcoder converting the multi-streams read-out by the read-out unit into transport streams appropriate to the DTV; a second transcoder converting the interactive contents read out by the read-out unit into DTV interactive contents; and a generator multiplexing the transport streams and the DTV interactive contents and generating DTV streams according to the reproduction control information read out by the read-out unit.

According to an aspect of the present invention, there is provided an apparatus to convert information stored in an information storage medium to DTV streams, including: a read-out unit reading out the information recorded on the information storage medium comprising multi-streams, interactive contents, and navigation information; a signal processing unit processing the read-out information into reproduction signals; a first transcoder converting the multi-streams into transport streams; a second transcoder converting the interactive contents into DTV interactive contents; a DTV-stream generator generating DTV streams using the transport streams and the DTV interactive contents; and a navigation engine controlling the DTV-stream generator based on the navigation information.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become more apparent by describing in detail a preferred embodiment thereof with reference to the attached drawings in which:

FIG. 1 is a block diagram illustrating a conventional DVD-video reproducing apparatus;

FIG. 2 is a reference diagram illustrating data recorded on an information storage medium, according to an aspect of the present invention;

FIG. 3 is a block diagram illustrating an apparatus for converting DTV streams, according to an aspect of the present invention;

FIG. 4 is a detailed block diagram illustrating a first transcoder of FIG. 3, according to an aspect of the present invention; and

FIGS. 5A and 5B are reference diagrams illustrating an example of converting an MPEG-PS input to a first transcoder of FIG. 4 into an MPEG-TS.

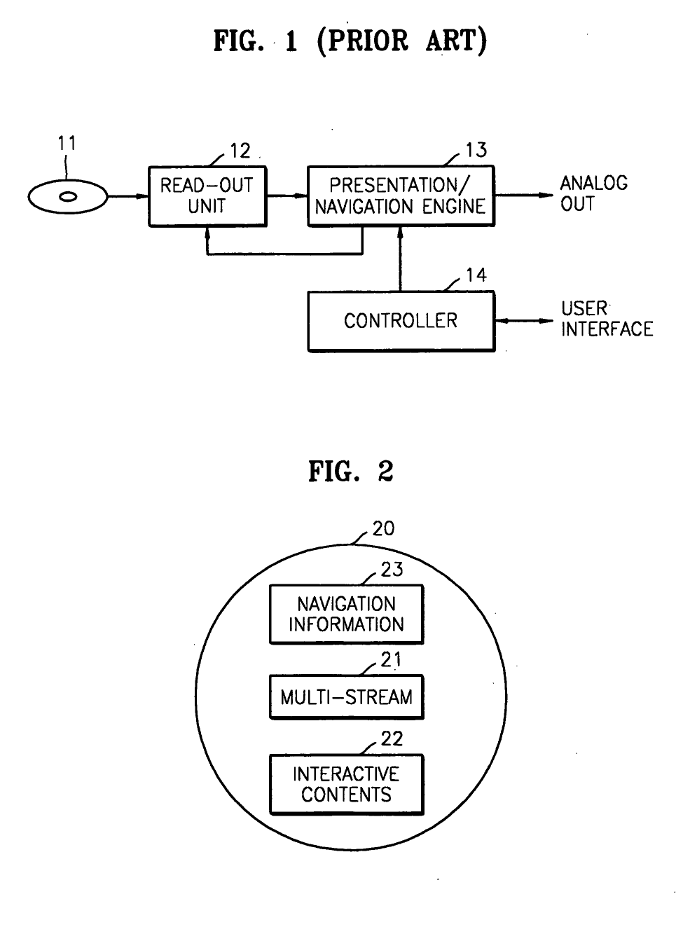

### DETAILED DESCRIPTION OF THE PREFERRED EMBODIMENTS

Reference will now be made in detail to the present aspects of the present invention, examples of which are illustrated in the accompanying drawings, wherein like reference numerals refer to the like elements throughout. The aspects are described below in order to explain the present invention by referring to the figures.

FIG. 2 is a block diagram illustrating data recorded on an information storage medium, according to an aspect of the present invention.

Referring to FIG. 2, the data recorded on an optical disc 20 is formed of multi-streams 21, interactive contents 22, and navigation information 23, as separate streams. Here, the multi-streams 21 denote audio and/or video (AV) stream and subpicture data. The AV stream may have a transport format, for example, moving picture experts group-2 program stream (MPEG-2 PS), MPEG-4, MPEG-7, and/or a wavelet transform. The interactive contents 22 denotes markup document files, such as HTML, XHTML, and XML, and files included in the markup document files, such as joint photographic experts group (JPEG) and portable network graphics (PNG) files. The navigation information 23, i.e., reproduction control information, includes reproduction information including management information and search information to reproduce the multi-streams 21 and the interactive contents 22, and conversion information to convert the multi-streams 21 and the interactive contents 22 into DTV streams. The navigation information 23 also includes information on a relationship between the multi-streams 21 and the interactive contents 22 in order for the multi-streams 21 and the interactive contents 22 to be converted synchronously and in relation to each other. In addition, the navigation information 23 includes information to distinguish the multi-streams 21 from the interactive contents 22 and control information to control the generation of the DTV streams.

In other words, the navigation information 23 includes information on the types of the multi-streams 21 and the interactive contents 22, time information to synchronously reproduce and synchronously convert the multi-streams 21 and the interactive contents 22, time information to independently reproduce and independently convert the multi-streams 21 and the interactive contents 22, parental ranking information on the multi-streams 21 and the interactive contents 22, information on a start time, reproduction period, and titles of the multi-streams 21 and the interactive contents 22, and information on detailed descriptions of the multi-streams 21 and the interactive contents 22.

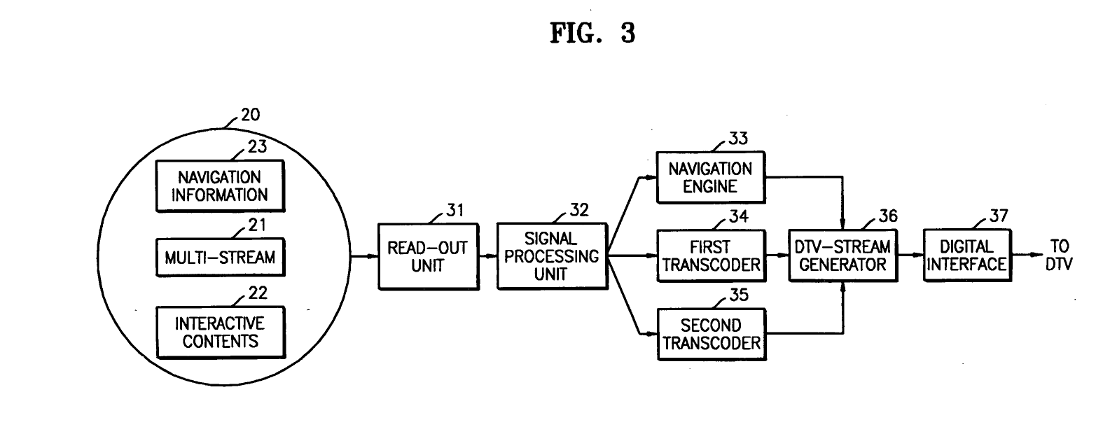

FIG. 3 is a block diagram illustrating an apparatus to convert DTV streams, according to an aspect of the present invention.

Referring to FIG. 3, a read-out unit 31 reads out information recorded on the optical disc 20, i.e., the multi-streams 21, the interactive contents 22, and the navigation information 23, and provides the read-out information-to a signal processing unit 32. The signal processing unit 32 processes the read-out information into reproduction signals, which are transmitted to the navigation information 23, the multi-streams 21, and the interactive contents 22 to a navigation engine 33, a first transcoder 34, and a second transcoder 35, respectively. The navigation engine 33 controls a DTV stream generator 36 based on the navigation information 23 provided from the signal processing unit 32.

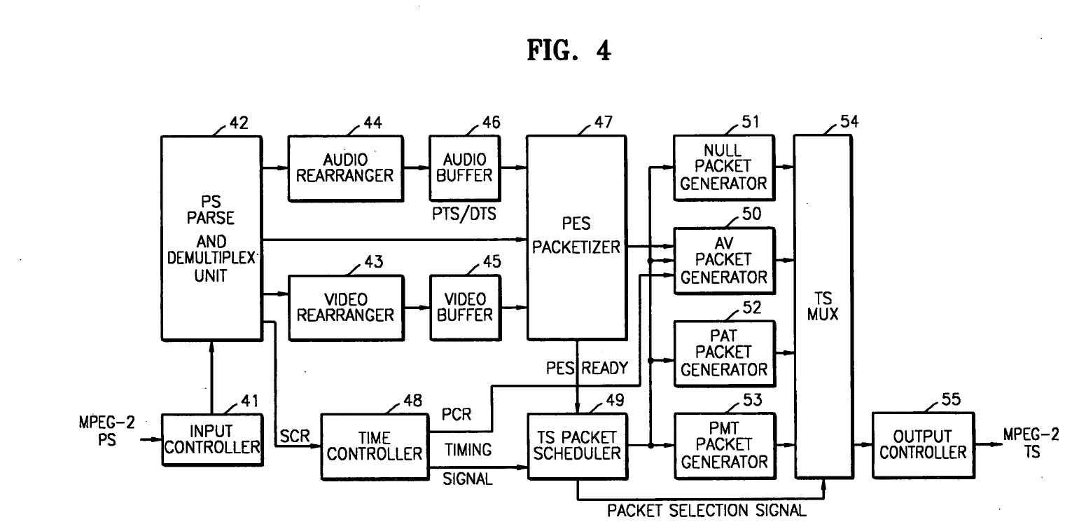

The first transcoder 34 converts the multi-streams 21 provided from the signal processing unit 32 into an MPEG-2 TS. A structure of the first transcoder 34 that converts the MPEG-2 PS into the MPEG-2 TS will be described later with reference to FIG. 4.

The second transcoder 35 converts the interactive contents 22 read out by the read-out unit 31 into DTV interactive contents. A process of converting an HTML document as a source document into a DTV-HTML document in the second transcoder 35 is as follows.

Step 1: a validation of the source document, for example, the HTML document, is checked.

Step 2: if the source document is validated, comments, process indicators, document type declarations, start tags, end tags, named character references, numeric character references, marked sections, and parsed character data (#PCDATA) contents in the source document are converted according to a DTV-HTML format. Thereafter, the converted values are output to a target document, i.e., the DTV-HTML document. In this case, open elements, which do not have the start tags or the end tags, maintain a stack during steps 1 and 2 in order to apply the start tags or the end tags that are omitted in the source document.

An example of the HTML document recorded on the optical disc 20 is as follows.

<body>
<p>text1</p>
<basefont size=“1”>
<p>text2</p>
<basefont size=“1” color=“red”>
<p>text3</p>
<basefont size=“3” face=“Arial Bold”>
<p>text4</p>
<basefont size=“4” color=“blue” face=“ ”>
<p>text5</p>
</body>

An example of the DTV-HTML document that is obtained by performing steps 1 and 2 on the HTML document recorded on the optical disc 20, in the second transcoder 35, is as follows.

<body>
<p>text1</p>
<!-- map 1st basefont -->
<div style=“display:inline; font-size:xx-small”>
<p>text2</p>
</div>
<!-- map 2nd basefont >
<div style=“display:inline; font-size:xx-small; color:red”>
<p>text3</p>
</div>
<!-- map 3rd basefont -->
<div style=“display:inline; font-size:medium; color:red; font-family:‘Arial bold’”>
<p>text4</p>
</div>
<!-- map 4th basefont -->
<div style=“display:inline; font-size:large; color:blue”>
<p>text5</p>
</div>
</body>

The DTV stream generator 36 generates DTV streams by using the MPEG-2 TS stream generated in the first transcoder 34 and the DTV-HTML data generated in the second transcoder 35, based on the conversion information provided from the navigation engine 33. In addition, the DTV stream generator 36 transfers the DTV streams to the DTV via a digital interface 37 that enables data to be input bidirectionally. An example of the digital interface 37 includes an IEEE 1394 interface.

The DTV stream generator 36 converts the data generated in the second transcoder 35, for example, the DTV-HTML data, into data following a digital storage media command and controls a (DSM-CC) standard to generate a DSM-CC message. In addition, the DTV stream generator 36 forms program and system information protocol (PSIP) information by using the conversion information, and program association table (PAT) information and program map table (PMT) information generated in the first transcoder 34. Here, the conversion information to convert the data into the DTV streams is included in the navigation information 23 provided from the navigation engine 33. The generated PSIP information is converted into a private section. Thereafter, the PSIP private section and the DSM-CC message are multiplexed with the MPEG-2 TS so that the DTV streams are generated.

In addition, the PSIP, a standard defined by the advanced television system committee (ATSC), is used to transfer information on the MPEG-2 transport stream and an electronic program guide (EPG). Tables defined by the PSIP are formed based on a standard of a private table that is defined in the MPEG-2 system. In addition, the tables are multiplexed with the A/V data that includes a program to be transferred.

The tables defined in the PSIP include a system time table (STT) used to transfer current date and time, a master guide table (MGT) including versions and TS packet identifiers of the tables to be transferred, a virtual channel table (VCT) formed by extending a program connection table of the MPEG-2 system to provide names and carrier frequencies of channels, an event information table (EIT) used to guide information on programs currently broadcast on virtual channels or to be broadcast, and an extended text table (ETT) to transfer additional information on the programs included in the EIT.

On the other hand, the DSM-CC is a standard defined by the MPEG to remotely control multimedia service. The systems controlled by the DSM-CC are divided into a user system with a client and a server, and a network system including a service and resource manager (SRM). Here, the interfaces between the user system and the network system defined by the DSM-CC include a user-to-user (UU) interface and a user-to-network (UN) interface. In the DSM-CC standard, the requirements of a physical layer, a data link layer, a transport layer, and a remote procedure call (RPC) layer that are related to the transfer are defined.

Messages transferred between the UU interface and the UN interface are formed of a typical message header and a message including contents. A UU message includes an RPC message and a session control message, and a UN message includes a network set message, a service and resource management message, and a download message. Here, the UN download message can be used to transfer additional data that is used for a data broadcasting. Methods of transferring the UN download message include a flow-controlled download method, a non-flow-controlled download method, and a data carousel method. Here, the flow-controlled download-method transfers all of the data from one server to one client, and the non-flow-controlled download method transfers all of the data from one server to a plurality of clients. In the data carousel method, one server periodically transfers the data and each client receives necessary portions of the data. Among the methods of transferring the UN download message, the non-flow-controlled method and the data carousel method are used for data broadcasting, based on the ATSC.

FIG. 4 is a detailed block diagram illustrating the first transcoder 34 of FIG. 3, according to an aspect of the present invention. Here, the MPEG-2 PS is converted into the MPEG-2 TS.

Referring to FIG. 4, if the multi-streams 22 read out by the read-out unit 31 are the MPEG-2 PS, an input controller 41 receives the PS data via the signal processing unit 32 of FIG. 3. Here, the input controller 41 includes a buffer to disenable the PS data when the buffer level is very low. In addition, an output controller 55 controls the MPEG-2 TS output according to the level of an internal buffer.

A PS parse and demultiplex unit 43 parses-the packet and the packetized elementary stream (PES) of the PS data provided via the input controller 41. The PS parse and demultiplex unit 42 extracts a video elementary stream (ES) and an audio ES from the PS data. The PS parse and demultiplex unit 42 extracts a system clock reference (SCR) from the packet to provide to a time controller 48, and extracts presentation time stamp/decoding time stamp (PTS/DTS) from a PES header to provide to a PES packetizer 47.

A video rearranger 42 searches a sequence start code and a picture start code from the video ES that is output from the PS parse and demultiplex unit 42 to generate recognition signals by access unit. Here, if the PTS/DTS are present, the PTS/DTS are recorded in an internal register.

An audio rearranger 44 obtains the frame size of the audio ES output from the PS parse and demultiplex unit 42 based on audio synchronization information, and generates recognition signals through an access unit (not shown). Here, when the PTS is present in the audio ES, the PTS is recorded in an internal register. A video buffer 45 and an audio buffer 46 store the outputs of the video rearranger 43 and the audio rearranger 44, respectively. Here, the video buffer 45 and the audio buffer 46 may store 184 bytes, which is a maximum payload of the TS packet.

The PES packetizer 47 assigns the PES header to the outputs of the video buffer 45 and the audio buffer 46 by access unit based on the recognition signals that are generated in the video rearranger 43 and the audio rearranger 44. Thereafter, the PES packetizer 47 provides a control signal PES READY to a TS packet scheduler 49 after inserting proper time stamps into the outputs of the video buffer 45 and the audio buffer 46. A time controller 48 sets an internal timer by using the SCR value of an initial pack that is provided from the PS parse and demultiplex unit 42. Thereafter, the time controller 48 generates a time control signal that determines a time alignment of an AV packet generator 50 by using a sequential SCR value, based on the SCR value of the initial pack. In other words, when a current count value counted by the timer is equal to or larger than the SCR value, the AV packet generator 50 is enabled. In another case, the AV packet generator 50 is disabled until the counted value becomes equal to the SCR value. In-addition, a program clock reference (PCR) that is generated using the SCR value in the timer of the time controller 48 is sampled to generate and provide a period signal of a program specific information (PSI) packet to the TS packet scheduler 49. Furthermore, a period signal of PCR insertion is generated and provided to the AV packet generator 50.

The TS packet scheduler 49 schedules AV packets generated by the AV packet generator 50, Null packets generated by a Null packet generator 51, PAT packets generated by a PAT packet generator 52, and PMT packets generated by a PMT packet generator 53. Here, a priority of the packets includes the AV packets being at a higher priority than the PAT packets and the PMT packets being at a higher priority than the Null packets. In this case, the time adjustment of the AV packets is determined according to a presence of the time control signal generated by the time controller 48. In addition, the TS packet scheduler 49 alternately schedules the PAT packets and the PMT packets whenever the PSI period signals are generated in the time controller 48. Furthermore, a TS multiplexer (TS MUX) 54 multiplexes the AV packets, the PAT packets, the PMT packets, and the Null packets according to the signal provided from the TS packet scheduler 49 and outputs the MPEG-2 TS via the output controller 55.

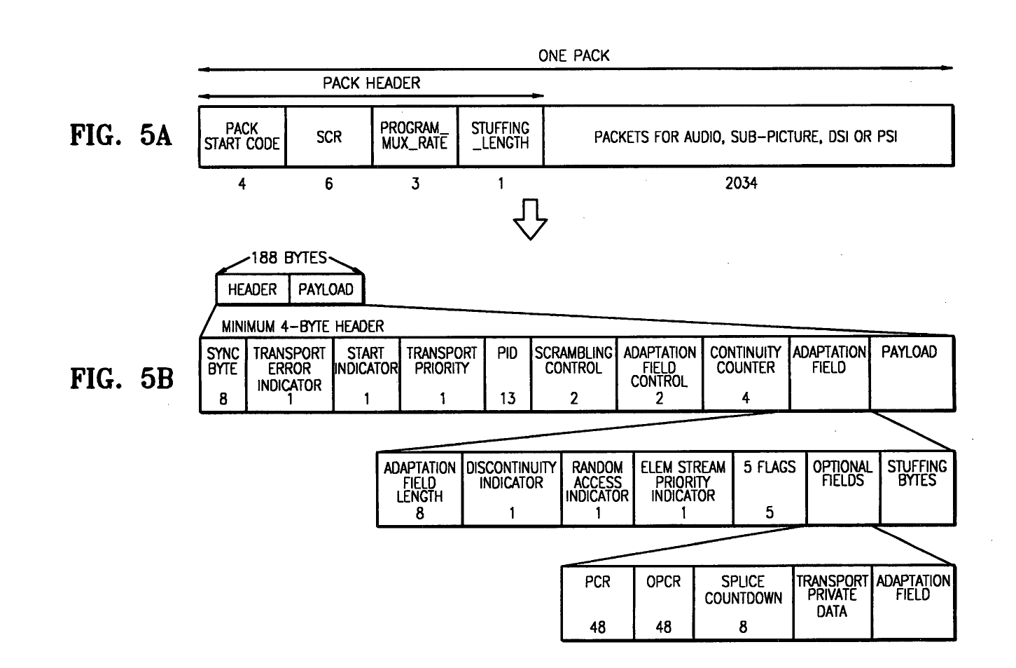

FIGS. 5A and 5B are reference diagrams illustrating an example of converting the MPEG-PS into the MPEG-TS by the first transcoder 34 of FIG. 4. Here, the MPEG-PS of pack unit is formed of a pack header, and packets for video, audio, sub-picture, and decoding specific information (DSI) or PSI, as shown in FIG. 5A. The MPEG-TS output from the first-transcoder 34 is formed of the TS packet of, 188 bytes including a header and a payload, as shown in FIG. 5B. A structure and contents of the header are shown in FIG. 5B, so descriptions of the structure and the contents of the header will be omitted.

As described above, the present invention provides an information storage medium including multi-streams, interactive contents, and reproduction control information having information on generation of DTV streams. In addition, according to an aspect of the present, invention, information, recorded on the information storage medium according to a standard which is hot related to DTV data, can be reproduced on a DTV by converting the multi-streams and the interactive contents into DTV streams by using the reproduction control information on the information storage medium.

While this invention has been particularly shown and described with reference to aspects thereof, it will be understood by those skilled in the art that various changes in form and details may be made therein without departing from the spirit and scope of the invention as defined by the appended claims.

What is claimed is:

1. An information storage medium, comprising:
multi-streams;
interactive contents comprising information that enables an interface with a user; and
reproduction control information comprising conversion information to convert the multi-streams and/or the interactive contents into digital television (DTV) streams.

2. The information storage medium of claim 1, wherein the multi-streams comprise a moving picture experts group-2 program stream (MPEG-2 PS), an MPEG-4 format stream, an MPEG-7 format stream, and/or a Wavelet transform format stream.

3. The information storage medium of claim 1, wherein the reproduction control information further comprises:
identification information identifying the multi-streams from the interactive contents to perform a DTV stream conversion; and
control information controlling a generation of the DTV streams.

4. The information storage medium of claim 1, wherein the reproduction control information further comprises management information and search information to reproduce the multi-streams and the interactive contents.

5. The information storage medium of claim 4, wherein the reproduction control information further comprises:
information on types of the multi-streams and the interactive contents;
time information to synchronously reproduce and synchronously convert the multi-streams and the interactive contents;
time information to independently reproduce and independently convert the multi-streams and the interactive contents;
parental ranking information on the multi-streams and the interactive contents;
additional information on start times, reproduction periods, and titles of the multi-streams and the interactive contents; and
information of detailed descriptions of the multi-streams and the interactive contents.

6. A method of reproducing data recorded on an information storage medium of a DTV, the method comprising:
reading out multi-streams, interactive contents, and reproduction control information from the information storage medium having conversion information to convert the multi-streams and/or the interactive contents into DTV streams;
converting the read-out multi-streams into transport streams appropriate to the DTV;
converting the read-out interactive contents into DTV interactive contents; and
multiplexing the transport streams and the DTV interactive contents based on the read-out reproduction control information to generate DTV streams.

7. The method of claim 6, wherein the multi-streams comprise an MPEG-2 PS, an MPEG-4 format stream, an MPEG-7 format stream, and/or a Wavelet transform format stream.

8. The method of claim 7, wherein the MPEG-2 PS is converted into an MPEG-2 TS during the conversion of the-transport streams.

9. The method of claim 8, wherein converting the transport streams comprises:
parsing a pack and a packetized elementary stream (PES) of read-out PS data to extract a video elementary stream (ES) and an audio ES, to extract a system clock reference (SCR) from the pack and to extract presentation time stamp/decoding time stamp (PTS/DTS) from a PES header;
assigning the PES header to the video ES and the audio ES;
inserting a proper time stamp based on the PTS/DTS;
setting an internal timer to be an SCR value of an initial pack;
generating a time control signal by determining a time alignment based on the SCR value of a sequential pack;
sampling a program clock reference (PCR) obtained using the SCR to generate a program specific information (PSI) packet period signal and a PCR insertion period signal;
generating AV packets using a result of inserting the time stamp according to the PCR insertion period signal, and generating program association table (PAT) packets, program map table (PMT) packets, and Null packets;
scheduling the AV packets, the PAT packets, the PMT packets, and the Null packets, while a time control of the AV packets is determined based on the time control signal, and the PAT packets and the PMT packets are alternately scheduled whenever the PSI packet period signals are generated; and
multiplexing the AV packets, the PAT packets, the PMT packets, and the Null packets to generate the MPEG-2 TS.

10. The method of claim 6, wherein converting the DTV interactive contents comprises:
checking a validation of the interactive contents comprising a source document, which is recorded on the information storage medium; and
when the source document is validated, converting comments, process indicators, document type declarations, start tags, end tags, named character references, numeric character references, marked sections, and parsed character data in the source document into a DTV document format to generate a target document comprising the DTV interactive contents.

11. The method of claim 9, wherein generating the DTV streams comprises:
converting the transport streams and the DTV interactive contents into a digital storage media command and control (DSM-CC) standard to generate a DSM-CC message;
forming program and system information protocol (PSIP) information by using information related to a DTV stream conversion in the reproduction control information, and PAT and PMT information;
converting the PSIP information into a PSIP private section; and
multiplexing the PSIP private section and the DSM-CC message with the MPEG-2 TS to generate the DTV streams.

12. An optical recording/reproducing apparatus to reproduce data recorded on an information recording medium on a DTV, the apparatus comprising:
a read-out unit reading out multi-streams, interactive contents, and reproduction control information from the information storage medium having conversion information to convert the multi-streams and/or the interactive contents into DTV streams;
a first transcoder converting the multi-streams read-out by the read-out unit into transport streams appropriate to the DTV;
a second transcoder converting the interactive contents read out by the read-out unit into DTV interactive contents; and
a generator multiplexing the transport streams and the DTV interactive contents and generating DTV streams according to the reproduction control information read out by the read-out unit.

13. The apparatus of claim 12, further comprising:
a digital interface interfacing the DTV streams generated by the generator to transfer to the DTV.

14. The apparatus of claim 12, wherein the multi-streams comprise an MPEG-2 PS, an MPEG-4 format stream, an MPEG-7 stream, and/or a Wavelet transform format stream.

15. The apparatus of claim 14, wherein the first transcoder converts the MPEG-2 PS into an MPEG-2 TS.

16. The apparatus of claim 15, wherein the first transcoder comprises:
a PS parse and demultiplex unit parsing a pack and a PES in PS data read out by the read-out unit to extract a video ES and an audio ES, an SCR from the pack, and PTS/DTS from a PES header;
a video rearranger searching a sequence start code and a picture start code in the video ES output from the PS parse and demultiplex unit to generate a first recognition signal by access unit and to extract the PTS/DTS;
an audio rearranger obtaining a frame size according to audio synchronization information in the audio ES output from the PS parse and demultiplex unit to generate a second recognition signal by access unit and to extract the PTS;
a PES packetizer assigning the PES header to the outputs of the video rearranger and the audio rearranger according to the first and second recognition signals, and inserting time stamps, which are obtained based on the PTS/DTS extracted by the video rearranger;
a time controller determining a time alignment of an AV packet by using an SCR value following the SCR value of an initial pack provided from the PS parse and demultiplex unit to generate a time control signal, and generating a PSI packet period signal and a PCR insertion period signal by sampling the PCR that is obtained using the SCR value;
an AV packet generator generating the AV packets from the output of the PES packetizer according to the PCR insertion period signal;
a PAT packet generator generating PAT packets;
a PMT generator generating PMT packets;
a Null packet generator generating Null packets;
a TS packet scheduler generating a packet selection signal and schedules the AV packets, the PAT packets, the PMT packets, and the Null packets, wherein the time control of the AV packets is determined according to a presence of the time control signal, and the PAT packets and the PMT packets are alternately scheduled when the PSI packet period signals are generated; and
a TS multiplexer multiplexing the AV packets, the PAT packets, the PMT packets, and the Null packets according to the packet selection signal to output the MPEG-2 TS.

17. The apparatus of claim 16, wherein a priority of the TS packet scheduler comprises the AV packets being at a higher priority than the PAT packets and the PMT packets being at a higher priority than the Null packets

18. The apparatus of claim 12, wherein a validation of a source document comprising the interactive contents recorded on the information storage medium, is checked in the second transcoder, and if the source document is validated, comments, process indicators, document type declarations, start tags, end tags, named character references, numeric character references, marked sections, and parsed character data are converted into a DTV document format to generate a target document comprising DTV interactive contents.

19. The apparatus of claim 16, wherein the generator converts the transport streams generated by the first transcorder and the DTV interactive streams generated by the second transcoder into a DSM-CC standard to generate a DSM-CC message, forms PSIP information using information on the DTV stream conversion in the reproduction control information, and the PAT and PMT information generated by the second transcoder, converts the PSIP information into a PSIP private section, and generates the DTV streams by multiplexing the PSIP private section and the DSM-CC message with the MPEG-2 TS output from the TS multiplexer.

20. An apparatus to convert information stored in an information storage medium to DTV streams, comprising:
a read-out unit reading out the information recorded on the information storage medium comprising multi-streams, interactive contents, and navigation information;
a signal processing unit processing the read-out information into reproduction signals;
a first transcoder converting the multi-streams into transport streams;
a second transcoder converting the interactive contents into DTV interactive contents;
a DTV-stream generator generating DTV streams using the transport streams and the DTV interactive contents; and
a navigation engine controlling the DTV-stream generator based on the navigation information.

21. The apparatus of claim 20, further comprising:
a digital interface receiving the DTV streams from the DTV-stream generator and enabling data to be input bi-directionally.

22. The apparatus of claim 20, wherein the digital interface comprises a user-to-user (UU) interface or a user-to-network (UN) interface.

23. The apparatus of claim 20, wherein the multi-streams comprise audio and/or video (AV) stream and subpicture data, where the AV stream has a transport format comprising at least one of moving picture experts group-2 program stream (MPEG-2 PS), MPEG-4, MPEG-7, or a wavelet transform.

24. The apparatus of claim 20, wherein the interactive contents comprises HTML, XHTML, or XML, and joint photographic experts group (JPEG) and portable network graphics (PNG) files.

25. The apparatus of claim 20, wherein the reproduction control information comprises:
reproduction information comprising management information and search information to reproduce the multi-streams and the interactive contents, and conversion information to convert the multi-streams and the interactive contents into DTV streams,
information on a relationship between the multi-streams and the interactive contents in order for the multi-streams and the interactive contents to be converted synchronously and in relation to each other, and
information to distinguish the multi-streams from the interactive contents and control information to control the generation of the DTV streams.

26. The apparatus of claim 20, wherein the navigation information comprises information on types of the multi-streams and the interactive contents, time information to synchronously reproduce and synchronously convert the multi-streams and the interactive contents, time information to independently reproduce and independently convert the multi-streams and the interactive contents parental ranking information on the multi-streams and the interactive contents, information on a start time, reproduction period, and titles of the multi-streams and the interactive contents, and information on detailed descriptions of the multi-streams and the interactive contents.

27. The apparatus of claim 20, wherein the DTV stream generator
converts the DTV interactive contents into data following a digital storage media command and controls a (DSM-CC) standard to generate a DSM-CC message, and
forms program and system information protocol (PSIP) information by using the conversion information, and program association table (PAT) information and program map table (PMT) information generated in the first transcoder.

28. The apparatus of claim 27, wherein the PSIP information is converted into a private section and the private section and the DSM-CC message are multiplexed with the transport streams to generate the DTV streams.

29. The apparatus of claim 20, wherein the second transcoder converts the interactive contents into DTV interactive contents by validating a source document in the interactive contents and, if the source document is validated, comments, process indicators, document type declarations, start tags, end tags, named character references, numeric character references, marked sections, and parsed character data (#PCDATA) contents in the source document are converted according to a DTV-HTML format.
